(19) United States
(12) Patent Application Publication
(10) Pub. No.: US 2008/0270747 A1
(43) Pub. Date: Oct. 30, 2008

(54) Method and Device for Switching Over Between Operating Modes of a Multi-Processor System Using at Least One External Signal

(76) Inventors: Wolfgang Pfeiffer, Grossbottwar (DE); Reinhard Weiberle, Vaihingen/Enz (DE); Bernd Mueller, Gerlingen (DE); Florian Hartwich, Reutlingen (DE); Werner Harter, Illingen (DE); Ralf Angerbauer, Schwieberdingen (DE); Eberhard Boehl, Reutlingen (DE); Thomas Kottke, Ehningen (DE); Yorch von Collani, Beilstein (DE); Rainer Gmehlich, Ditzingen (DE); Karsten Graebitz, Asperg (DE)

Correspondence Address: KENYON & KENYON LLP, ONE BROADWAY, NEW YORK, NY, 10004, US

(21) Appl. No.: 11/666,325

(22) PCT Filed: Oct. 25, 2005
(86) PCT No.: PCT/EP05/55509

§ 371 Date: Mar. 18, 2008

(30) Foreign Application Priority Data
Oct. 25, 2004 (DE) 102004051937.4
Oct. 25, 2004 (DE) 102004051950.1
Oct. 25, 2004 (DE) 102004051952.8
Oct. 25, 2004 (DE) 102004051964.1
Oct. 25, 2004 (DE) 102004051992.7
Aug. 8, 2005 (DE) 102005037213.9

(51) Int. Cl. G06F 9/318

(52) U.S. Cl. 712/20; 712/E09.035

(57) ABSTRACT

A method for a switchover in a computer system having at least two execution units, a switchover being performed between at least two operating modes, and a first operating mode corresponding to a comparison mode, and a second operating mode corresponding to a performance mode, wherein the switchover is triggered by at least one signal, which is generated outside the computer system.

### FIELD OF THE INVENTION

The present invention relates to a device and a method for switching over between at least two operating modes of a multi-processor system having at least two execution units.

### BACKGROUND INFORMATION

Transient errors, triggered by alpha particles or cosmic radiation, are increasingly becoming a problem for integrated semiconductor circuits. Due to decreasing pattern widths, decreasing voltages, and higher pulse frequencies, the likelihood increases that a voltage peak, caused by alpha particles or cosmic radiation, will distort a logic value in an integrated circuit. An erroneous computation result may occur. Such errors must be reliably detected in safety-relevant systems, in a motor vehicle in particular.

In safety-relevant systems, such as an ABS control system in a motor vehicle, in which malfunctions of the electronics must be reliably detected, redundancies for error detection are typically used in the respective control devices of such systems. For example, the complete microcontroller is duplicated in conventional ABS systems and all ABS functions are computed redundantly and checked for agreement. If a discrepancy occurs in the results, the ABS system is shut off.

A microcontroller is made up of memory modules (e.g., RAM, ROM, Cache), a processor (CPU, Core), and input/output interfaces known as peripherals (e.g., A/D converter, CAN interface). Since memory elements may be effectively monitored using check codes (Parity or ECC) and peripherals are often monitored application-specifically as part of a sensor or actuator signal path, a further redundancy approach is the mere doubling of the cores (CPUs) of a microcontroller.

Such microcontrollers having at least two integrated cores are also known as dual-core or multi-core architectures. Both cores execute the same program segment in a redundant and pulse-synchronous manner; the results of both execution units are compared and an error is then detected upon comparison for agreement. This configuration of a multi-core system is referred to in the following as comparison mode.

Dual-core or multi-core architectures are also used in other applications for increased efficiency, i.e., for improvement in performance. Both cores execute different programs, thereby increasing efficiency, and therefore this configuration of a multi-core system is referred to as efficiency mode or performance mode. This system is also referred to as a symmetrical multiprocessor system (SMP).

An extension of these systems may be achieved via switchover, i.e., depending on the application purpose of the multiprocessor system it may be operated in a comparison mode or in a performance mode. The output signals of the cores are compared to each other in the comparison mode. An error signal is output in the event of a difference. In the performance mode, both cores operate as a symmetrical multi-processor system (SMP) and execute different programs.

### SUMMARY

Primarily in the automotive sector, certain systems respond to external events or as a function of external events. It may be advantageous in such systems to carry out a switchover as a function of conditions external to the processor (e.g., sensor values, system status, and vehicle status). Time-controlled communication systems will be increasingly used in the automobile in the future. It may be advantageous in connection with these communication systems to switch over the operating mode of a multi-processor system as a function of a global time basis of the communication system or as a function of other time events.

In real-time systems it may be useful for error treatment, among other things, to switch the operating mode of a multi-processor system from a redundancy mode (comparison mode) to a non-redundancy mode (performance mode) in order to make it possible to localize and treat errors separately. Different system modes (e.g., in a motor vehicle control system) may make different demands on the optimum processor modes. It may be useful here to run the same program in system mode 1 in a first operating mode of the processor system, while it advantageously runs in system mode 2 in a second operating mode of the processor system. A targeted switchover into a dedicated operating mode or the suppression of such a switchover as a function of external signals is not achieved in conventional systems, i.e., via a program-specific identifier or access to a certain memory address.

It is an object of the present invention to initiate a switchover between different operating modes as a function of an external signal.

An method for switching over in a computer system having at least two execution units is described, a switchover being performed between at least two operating modes, and a first operating mode corresponding to a comparison mode and a second operating mode corresponding to a performance mode, wherein the switchover is triggered by at least one signal which is generated outside of the computer system. An identifier is advantageously assigned to the external signal or it contains such an identifier, a switchover taking place only when the identifier is present. Using the identifier, it is established into which operating mode the switchover is made. The identifier contains a time condition using which it is established when the switchover is made. Using the external signal, a switchover is advantageously made only in one direction between the operating modes. Using the external signal, a switchover is advantageously made exclusively from the performance mode to the comparison mode. Using the external signal, a switchover is advantageously made exclusively from the comparison mode to the performance mode. The signal advantageously represents the triggering of an interrupt processing. The identifier advantageously corresponds to a predefined signal characteristic, in particular of a pulse-width modulated signal. The identifier advantageously corresponds to a predefined frequency. The identifier advantageously corresponds to a predefined bit sequence of a digital signal. The identifier advantageously corresponds to a predefined message ID of a message by a communication system. The switchover is advantageously triggered via a combination of at least one signal, which is generated outside the computer system, and at least one piece of information which is generated inside the computer system. A switchover advantageously takes place only when the at least one signal and the at least one piece of information internal to the computer system are present simultaneously. A switchover advantageously takes place only when time-limited switchover is enabled as a function of at least one external signal and when at least one piece of information internal to the computer system or an event internal to the computer system is present within the limited enable time. Advantageous is a switchover device contained in a computer system having at least two execution units which contain switchover means which are designed in such a way that they are switching over between at least two operating modes, a first operating mode representing a comparison mode and a second operating mode representing a performance mode wherein there is a receiver which receive at least one signal which is generated outside the computer system, switchover being triggered by the signal generated outside the computer system. A receiver for receiving the at least one external signal is advantageously an interrupt controller. Advantageously, there is a receiver, which receive at least one signal generated outside the computer system, and an arrangement which combines the signal received from outside or an identifier of same with an internally generated signal, switchover being triggered by a combination of at least one signal generated outside the computer system and at least one piece of information which is generated inside the computer system.

### BRIEF DESCRIPTION OF THE DRAWINGS

FIG. 1 shows a multiprocessor system having two execution units, devices for comparing data of the two execution units, and a switchover unit for switching over the operating modes.

FIG. 2 shows a multiprocessor system having two execution units, devices for comparing data of the two execution units, and a switchover unit for switching over the operating modes, and an external signal source which generates a switchover signal.

FIG. 3 shows a multiprocessor system having two execution units, devices for comparing data of the two execution units, and a switchover unit for switching over the operating modes, and an external signal source which is connected to an interrupt controller of the multiprocessor system.

FIG. 4 shows a multiprocessor system having two execution units, devices for comparing data of the two execution units, and a switchover unit for switching over the operating modes, and an external signal source which is connected to the multiprocessor system via a communication system.

FIG. 5 shows a general switchover and comparison unit.

### DETAILED DESCRIPTION OF EXAMPLE EMBODIMENTS

In the following, an execution unit may include, for example, processor/core/CPU as well as an FPU (floating point unit), a DSP (digital signal processor), a co-processor, or an ALU (arithmetic logical unit).

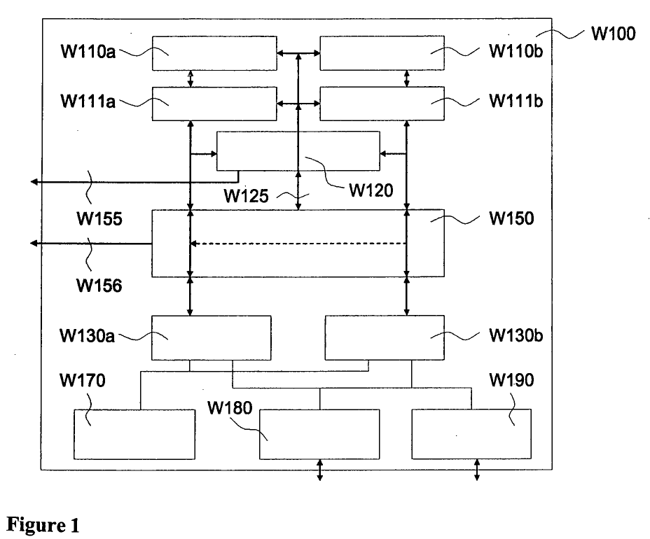

The present invention relates to a multiprocessor system W100 shown in FIG. 1 having at least two execution units W110a, W110b, a comparison unit W120, and a switchover unit W150. The execution units are each connected to a comparison unit W120 and a switchover unit W150 via an optional buffer memory W111a, W111b. Switchover unit W150 has at least two outputs to two system interfaces W130a, W130b. Registers, memories, or peripherals such as digital outputs, D/A converters, and communication controllers may be activated via these interfaces.

This multiprocessor system may be operated in at least two operating modes, a comparison mode VM and a performance mode PM.

Different instructions, program segments, or programs are executed in parallel in performance mode PM. The comparison unit is deactivated in this operating mode. Switchover unit W150 is configured in this operating mode in such a way that each execution unit is connected to one of system interfaces W130a, W130b via the optional buffer memory. A result of an execution unit may be written into a memory W170 or output to a peripheral module W180, W190 via the system interfaces. A peripheral module may be, for example, an analog/digital converter or a communication controller of a communication system (e.g., SPI, LIN, CAN, FlexRay).

There are several options for deactivating the comparison unit. A signal may be routed to the comparator by which it is activated or deactivated. For this purpose, an additional logic must be introduced into the comparator which is able to execute the activation and deactivation. Another option is to not convey any data to be compared to the comparator. A third option is to ignore the error signal of the comparator on the system level. Moreover, the error signal itself may be interrupted. All options have in common that they create a state in the system where it makes no difference when two or more pieces of information, which are potentially compared, are different. If this state is reached via a measure in the comparator or via its input or output signals, the comparator is then referred to as passive or deactivated.

In comparison mode VM, the same or similar commands, program segments, or programs are executed in both execution units W110a, W110b. The output signals of the execution units are conveyed to comparison unit W120 and to switchover unit W150 via optional buffer memories W111a, W111b. The two signals are checked for agreement in the comparison unit. After the comparison is carried out, the switchover unit is informed via a status signal W125 whether it is allowed to output one of the agreeing results to one of the system interfaces or whether it must block the signal because of a detected discrepancy in the results. In this case, an optional error signal W155 may be output by the comparison unit. This error signal may also be output by switchover unit W156 instead of being output by the comparison unit.

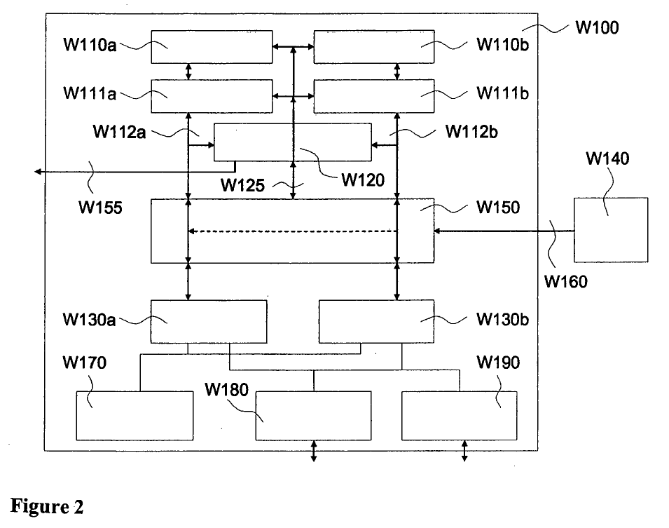

Switchover may be triggered either via executing special switchover instructions, special instruction sequences, and explicitly identified instructions or via access to a certain memory address by at least one of the cores of the multiprocessor system. In the present invention, switchover between the two operating modes of the multiprocessor system is triggered by at least one signal W160 which is generated by a device or a signal source W140 outside the computer system as shown in FIG. 2.

In a first exemplary embodiment, switchover takes place as a function of exactly one signal. This switchover may take place in such a way that, due to exactly one property of the signal, a change takes place from any first operating mode which the multiprocessor system is in at the time of reception of the signal into a second operating mode.

In a second exemplary embodiment, the switchover unit may be configured in such a way that, due to exactly one property of the signal, a change of the operating mode takes place in only one direction, i.e., from a first, initially defined operating mode into exactly one second, initially defined operating mode, e.g., from the performance mode into the comparison mode. If, at the time of reception of the signal, the multiprocessor system is already in the second operating mode defined as the target state, the switching signal has no further effect on the multiprocessor system. Switching into the other direction takes place otherwise using a conventional procedure, e.g., as a function of a signal or event internal to the processor, the access to a certain memory address, as a function of the execution of a certain program, program segment, or instruction, or via a second, external signal.

The above-mentioned property of the signal may be the presence of a signal or a signal level which is not reached or is exceeded.

In a third exemplary embodiment, switchover of the operating modes takes place as a function of at least one signal which is generated by a device or a signal source W140 outside the computer system and to which an identifier is assigned or which contains such an identifier, a switchover taking place only when the identifier is present. The identifier makes it possible to establish into which operating state the multiprocessor system is to be switched over. The identifier may contain a time condition and/or may correspond to a certain, predefined signal characteristic, e.g., the gradient of a signal, the duty factor of a pulse-width modulated signal, a predefined frequency of an alternating voltage signal, of a pulse-width modulated or frequency modulated signal, of a predefined bit sequence of a digital signal, of a predefined message ID of a message of a communication system.

The identifier may also be a combination of two or more of the above-mentioned signal characteristics.

Signal source W140 may be one of the following elements or a combination of several of the following elements:

Timer external to the microcontroller (e.g., of the time basis of a communication system), error signal of a unit external to the microcontroller (e.g., a watchdog in the SG), sensor signal, additional control unit, status signal of an application system (e.g., control status of an ABS system), emission limit of an internal combustion engine, ( . . . in an automobile system).

In a first embodiment variant, signal source W140 may be present exclusively for generating a switchover signal. As shown in FIG. 2, such a signal source may be connected to the multiprocessor system via a point-to-point connection W160, and there directly to switchover unit W150.

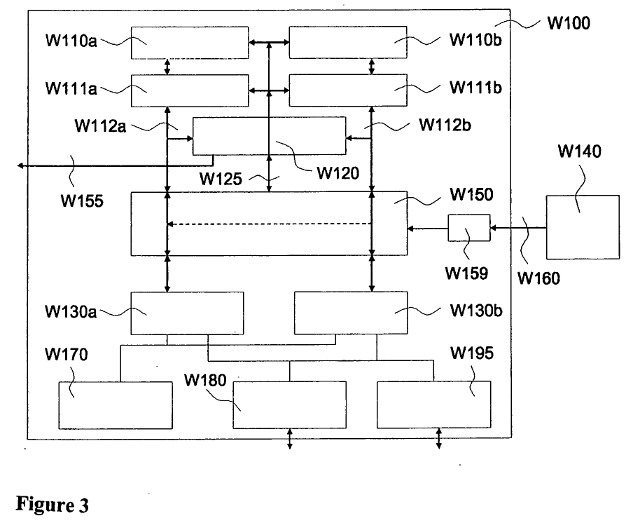

In a second embodiment variant, shown in FIG. 3, switchover signal W160 is received as an interrupt signal via an interrupt controller W159. The external signal causes triggering of an interrupt processing in this variant; switching over between the operating modes is then initiated by the interrupt controller.

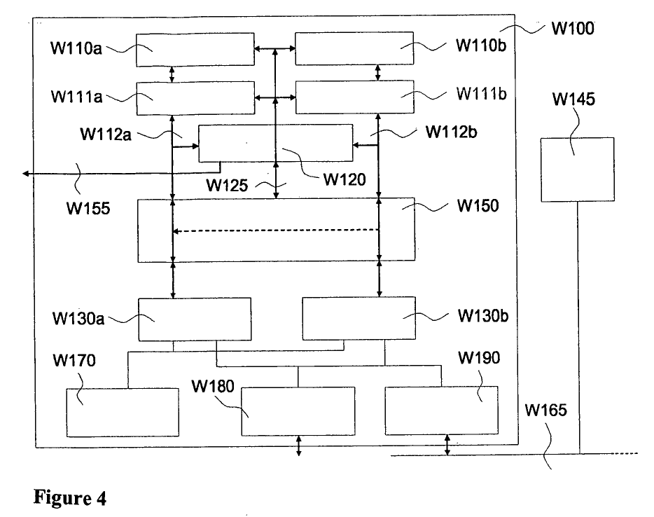

In a further embodiment variant as shown in FIG. 4, an additional control unit or an intelligent sensor W145, which is connected to the processor system via a communication system W165, may also be used as the signal source. The digital signal is then conveyed to switchover unit W150 via communication interface W195 and the internal data/address bus.

Any other combination of the described signal sources W140, W145, the type of signal connection W160, W165, and interrupt controller W159 is also possible.

In a further embodiment of the system, switching over between operating modes is not triggered exclusively by an external signal, but rather by a combination of at least one external signal and at least one piece of information, one event, or one signal which is generated inside the computer system. This event internal to the computer system may be, for example, the execution of a program instruction or access to a certain memory address. As shown in FIGS. 2, 3, and 4, switchover unit W150 receives this information via connections W112a, W112b between execution units W110a, W110b, or optional buffer memory W111a, W111b, comparison unit W120, and switchover unit W150. The signal combination advantageously takes place within switchover unit W150. In a first variant, the combination is designed in such a way that a switchover between the operating modes takes place only when the at least one external signal and the at least one piece of information are present simultaneously. In a further variant, the external signal enables only a switchover which is preferably limited in time. A switchover is then possible only when an internal event occurs within a defined time window after the enable signal.

Instead of enabling a switchover, the external signal may also trigger a cancellation of an enable or a blocking of a switchover. This is also preferably time-limited, whereby a switchover at certain points in time or in certain system states may be prevented.

A multiprocessor system including two execution units and two operating modes is described in the preceding exemplary embodiments. The characterizing features of the present invention may also be used in multiprocessor systems having more than two execution units. Changes are primarily necessary in this case in the switchover unit and the comparison unit.

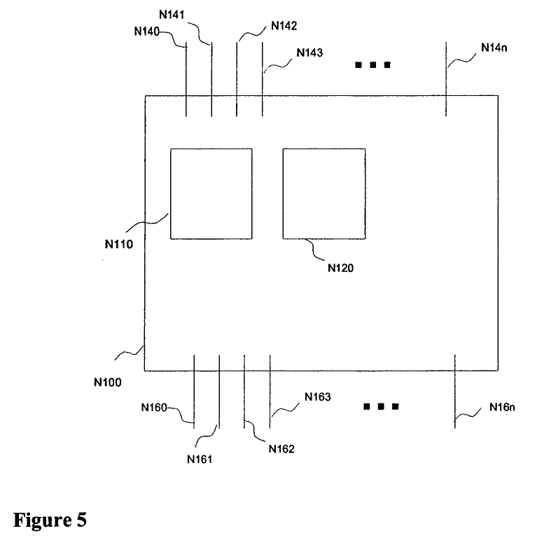

A general case of the switchover and comparison component which is also suitable for use in a system having more than two execution units is shown in FIG. 5, where n signals N140, . . . , N14n are conveyed from the n execution units to be considered to switchover and comparison component N100, which may generate n output signals N160, . . . , N16n from these input signals. In the simplest case, the “pure performance mode,” all signals N14i are directed to the respective output signals N16i. In the opposite borderline case, the “pure comparison mode,” all signals N140, . . . , N14n are reduced to exactly one of the output signals N16i.

More than only two operating modes are possible in a system having n execution units and n>2. Based on FIG. 5, it may be demonstrated how the different possible modes can be created. For this purpose, this figure contains the logic component of a switching logic N110 which initially establishes how many output signals are actually present. Moreover, switchover logic N110 establishes the dependency of the output signal on the input signals. Formulated mathematically, a function from set {N140, . . . , N14n} into set {N161, . . . , N16n} is defined by the switchover logic.

Processing logic N120 then establishes for each of outputs N16i in which form the inputs contribute to this output signal. In order to describe the different possible variations it is assumed, without limiting the generality, that output N160 is generated by signals N141, . . . , N14m. If m equals 1, this simply corresponds to a switching-through of the signal; if m equals 2 then signals N141, N142 are compared for agreement. This comparison may be carried out synchronously or asynchronously; it may be carried out bit-by-bit or only using significant bits or also using a tolerance band.

If m is equal to or greater than 3, then there are multiple options.

A first option is to compare all signals and, in the presence of at least two different values, to detect an error which may optionally be signaled.

A second option is to select k from m (k>m/2). This selection may be implemented by using comparators. An error signal may optionally be generated when one of the signals is recognized as being deviant. A further error signal may optionally be generated when all signals to be compared are different.

A third option is to supply these values to an algorithm. For example, this algorithm may represent the formation of a mean value or the use of an error-tolerant algorithm (ETA). The basis of such an ETA is to eliminate extreme values of the input values and to average the remaining values. This averaging may be carried out over the entire set of the remaining values or preferably over a subset easily formed in hardware. It is not always necessary in this case to actually compare the values. For example, forming the mean value requires only addition and division, while FTM, ETA or median require partial sorting. If needed, an error signal may optionally be output in the event of sufficiently great extreme values.

These different cited options of processing multiple signals into one signal are referred to as comparison operations for the sake of conciseness.

The object of the processing logic is to establish the exact form of the comparison operation for each output signal and thus also for the associated input signals. The combination of the information of switching logic N110 (i.e., the above-mentioned function) and of the processing logic (i.e., establishment of the comparison operation per output signal, i.e., per function value) is the mode information which establishes the mode. In the general case, this information is of course multivalued, i.e., it is not representable by only one logical bit. Not all theoretically possible modes are meaningful in one given implementation; the number of allowed modes is preferably restricted. It should be pointed out that in the case of only two execution units, where there is only one comparison mode, all the information may be compressed onto only one logical bit.

In the general case, a switchover from a performance mode to a comparison mode is characterized in that execution units, which are mapped onto different outputs in the performance mode, are mapped onto the same output in the comparison mode. This is preferably implemented in that there is a subsystem of execution units in which, in the performance mode, all input signals N14i, which are taken into account in the subsystem, are switched over directly to corresponding output signals N16i, while in the comparison mode, all input signals are mapped onto one output. In systems having more than three execution units, such a switchover may also be implemented alternatively by changing pairings. This is represented by the fact that one cannot talk in the general case about the performance mode and the comparison mode, although it is possible, in a given embodiment of the present invention, to restrict the set of allowed modes in such a way that this is the case. However, one can always talk about a switchover from a performance mode into a comparison mode (and vice versa).

1-18. (canceled)

19. A method for a switchover in a computer system, the computer system including at least two execution units, the method comprising:
performing a switchover between at least two operating modes, a first one of the operating modes corresponding to a comparison mode and, a second one of the operating modes corresponding to a performance mode;
wherein the switchover is triggered by at least one external signal which is generated outside the computer system.

20. The method as recited in claim 19, wherein an identifier is assigned to the external signal or the external signal contains the identifier, a switchover taking place only if the identifier is present.

21. The method as recited in claim 20, further comprising:
establishing into which of the operating modes the switchover is being made using the identifier.

22. The method as recited in claim 20, wherein the identifier contains a time condition using which it is established when the switchover is being made.

23. The method as recited in claim 19, wherein, using the external signal, the switchover is made between the operating modes only in one direction.

24. The method as recited in claim 19, wherein, using the external signal, the switchover is made exclusively from the performance mode into the comparison mode.

25. The method as recited in claim 19, wherein, using the external signal, the switchover is made exclusively from the comparison mode into the performance mode.

26. The method as recited in claim 19, wherein the external signal represents triggering of an interrupt processing.

27. The method as recited in claim 20, wherein the identifier corresponds to a predefined signal characteristic, the predefined signal characteristic being a characteristic of a pulse-width modulated signal.

28. The method as recited in claim 20, wherein the identifier corresponds to a predefined frequency.

29. The method as recited in claim 20, wherein the identifier corresponds to a predefined bit sequence of a digital signal.

30. The method as recited in claim 20, wherein the identifier corresponds to a predefined message ID of a message of a communication system.

31. The method as recited in claim 19, wherein the switchover is triggered by a combination made up by the at least one external signal and at least one piece of information which is generated inside the computer system.

32. The method as recited in claim 31, wherein a switchover takes place only when the at least one external signal and the at least one piece of information which is generated inside the computer system are present simultaneously.

33. The method as recited in claim 31, wherein the switchover takes place only when the switchover is enabled within a limited enable time as a function of the at least one external signal, and when at least one piece of information internal to the computer system or an event internal to the computer system exists for switchover within the limited enable time.

34. A device for switchover in a computer system having at least two execution units, the device comprising:
a switchover arrangement adapted to perform a switchover between at least two operating modes, a first one of the operating modes corresponding to a comparison mode, and a second one of the operating modes corresponding to a performance mode; and
a receiver adapted to receive at least one external signal generated outside the computer system, the switchover being triggered by the external signal.

35. The device as recited in claim 34, wherein the receiver is an interrupt controller.

36. The device as recited in claim 34, further comprising:
an arrangement adapted to combine the external signal or its identifier with an internally generated signal, the switchover being triggered by a combination of the external signal and at least one piece of information which is generated inside the computer system.
